(19) United States
(12) Patent Application Publication
(10) Pub. No.: US 2026/0205452 A1
(43) Pub. Date: Jul. 16, 2026

(54) CENTRALIZED PASSKEY MANAGEMENT SYSTEM FOR ENHANCED DIGITAL AUTHENTICATION AND SECURITY

(71) Applicant: Wells Fargo Bank, N.A., San Francisco, CA (US)

(72) Inventors: Teresa A. Calamita, Charlotte, SC (US); Miles Anthony Melvin, Huntersville, NC (US); Kimberly R. Nelson, Charlotte, NC (US); Matthew N. Wheeler, Charlotte, NC (US)

(21) Appl. No.: 19/025,062

(22) Filed: Jan. 16, 2025

(51) Int. Cl. H04L 9/40

(52) U.S. Cl. CPC H04L 63/083; H04L 63/0876

(57) ABSTRACT

Various examples are directed to systems, methods, and computer programs for managing digital authentication in a financial application. A method comprises causing display of a user interface with a passkey control center providing a centralized passkey management console. The method receives user input specifying authentication preferences for passkey types. Passkey types are associated with permissions based on the input. Upon receiving a financial service request, the method confirms the authentication preference for the relevant passkey type to identify an appropriate passkey. The financial service is then authenticated using the identified passkey. The centralized passkey management enables users to configure detailed authentication preferences and provides visibility into passkey usage across financial activities.

### TECHNICAL FIELD

Embodiments described herein generally relate to systems, methods, and machine-storage medium for digital security and user authentication, focusing on centralized management of passkeys. For example, embodiments described herein are directed to systems and methods for a centralized passkey management system for enhanced digital authentication and security.

### BACKGROUND

Security threats are an ever-increasing part of interacting with online systems. Systems that rely on only a password may be vulnerable to attacks. Some secure systems rely on multi-factor authentication and other complex security techniques, although these can be cumbersome or difficult to understand for those not well versed in technology. Intimidating technological solutions can lead wary users to adopting less secure habits, negating the benefits of these solutions. Digital authentication has become increasingly critical as online interactions and transactions have proliferated. Traditional password-based systems, while widely adopted, have long been recognized as vulnerable to various attacks, including brute force attempts, phishing, and password reuse across multiple platforms.

To address these vulnerabilities, the industry has developed and implemented multi-factor authentication (MFA) systems. These typically combine something the user knows, like a password, with something they have, such as a mobile device, or something they are, biometric data. Common MFA implementations include one-time passwords sent via Short Message Service (SMS), hardware tokens generating time-based codes, and fingerprint or facial recognition systems. More advanced authentication methods have also emerged, such as risk-based authentication, which analyzes various contextual factors to determine the level of authentication required for a given session. This can include factors like the user’s location, device characteristics, and behavioral patterns. Additional digital authenticators include Public Key Infrastructure (PKI) systems and Single Sign-On (SSO) solutions. Where PKI systems have been widely adopted for secure communications and identity verification, particularly in enterprise environments. These systems rely on digital certificates and a chain of trust to authenticate users and devices. SSO solutions have gained popularity, especially in corporate settings, allowing users to access multiple applications with a single set of credentials. This approach aims to reduce password fatigue and improve overall security by centralizing authentication.

Despite these advancements, the implementation of robust authentication systems often involves complex technical processes and user interfaces. This complexity can be challenging for non-technical users to understand and navigate, potentially leading to user frustration or the circumvention of security measures. The tension between security and usability remains a significant challenge in the field of digital authentication. Overly complex or intrusive security measures may inadvertently push users towards less secure practices, such as using easily guessable passwords or writing down credentials, thereby undermining the intended security benefits. Authentication and security are critical concerns for financial applications and services. Traditional password-based systems have vulnerabilities, and users often struggle to manage multiple complex passwords. Passkeys have emerged as a more secure alternative, but managing multiple passkeys across devices and services presents new challenges.

### BRIEF DESCRIPTION OF THE SEVERAL VIEWS OF THE DRAWINGS

The present disclosure will be apparent from the following more particular description of examples of embodiments of the technology, as illustrated in the accompanying drawings. In the drawings, which are not necessarily drawn to scale, like numerals may describe similar components in different views. Like numerals having different letter suffixes may represent different instances of similar components. To easily identify the discussion of any particular element or act, the most significant digit or digits in a reference number refer to the figure number in which that element is first introduced. Some embodiments are illustrated by way of example, and not limitation, in the figures of the accompanying drawings in which:

FIG. 1 is a diagram illustrating a network arrangement for a passkey control center of a financial institution, according to some example embodiments.

FIG. 2 is an example graphical user interface for the passkey control center, according to some example embodiments.

FIG. 3 is an example graphical user interface for managing passkey use preferences, according to some example embodiments.

FIG. 4 is an example graphical user interface for managing passkey types, according to some example embodiments.

FIG. 5 is a flow diagram illustrating secure management of a passkey associated with a financial institution, according to some example embodiments.

FIG. 6 illustrates a machine-learning pipeline, according to some example embodiments.

FIG. 7 illustrates training and use of a machine-learning program, according to some example embodiments.

FIG. 8 is a data flow diagram illustrating content generation with generative artificial intelligence, according to some example embodiments.

FIG. 9 is a block diagram showing an example architecture of a user computing device, according to some example embodiments.

FIG. 10 is a block diagram showing one example of a software architecture for a computing device, according to some example embodiments.

FIG. 11 is a block diagram illustrating a computing device hardware architecture, within which a set or sequence of instructions can be executed to cause a machine to perform examples of any one of the methodologies discussed herein, according to some example embodiments.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Example systems, methods, computer programs, machine-storage media described herein are directed to providing a centralized passkey management system, referred to throughout as a “passkey control center” for enhanced digital authentication and security for customers and users of a financial institution platform including a user interface to manage digital authentication employing passkeys. Examples of a passkey control center include a novel system that allows users, such as financial institution customers (e.g., banking customers, online banking “app” users, organizations, families, etc.), to manage their digital authentication keys (referred to as “passkeys”) via a user interface in a centralized location within a financial application. The passkey control center enables banking customers to set passkey types and passkey preferences associated with services of the financial institution. For example, the user’s passkeys can be stored in financial institution’s backend server, such as a security control server, which provides a digital platform for managing passkeys via a user-friendly dashboard of the financial institution. The user-friendly dashboard enables customers to view and manage their passkeys for the financial institution and associated with third-party services associated with the financial institution. Via a user interface, the passkey control center enables the customer to set custom rules for how each passkey can be used, such as only allowing certain passkeys for high-risk transactions like wire transfers, support both cloud-synced passkeys that work across multiple devices and device-specific passkeys that provide enhanced security, or the like. Examples of the passkey control center offer users options to configure which authentication methods (e.g., face identification (ID), fingerprint ID, voice ID, authentication application, or the like) can be used with each passkey in order to grant permissions to certain financial institution services according to certain passkeys preferences. Examples of the passkey control center can enable further user-configured options, such as tools to associate passkeys with specific financial products or services, functionality to delete, change, or revoke passkeys as needed, and additional configuration options according to the user’s preferences. By providing a centralized interface for managing complex authentication preferences, the passkey control center enables users more control and visibility over their digital authentication mechanisms while enhancing security for sensitive financial transactions.

A passkey is a digital credential, tied to a user account and a website or application. Passkeys allow users to authenticate without having to enter a username or password or provide any additional authentication factor. Passkey technology employed with the passkey control center can replace legacy authentication mechanisms, such as passwords. When a user wants to sign into a service, such as a financial institution platform for banking purposes, which uses passkeys, the user’s device’s browser or operating system will help the user select and use the proper (e.g., correct) passkey associated with the service. According to examples of the passkey control center, to ensure only the rightful owner (e.g., account owner, authorized user, etc.) can use a passkey, the system will ask the user to unlock their device. Unlocking the user’s device can be performed with a biometric sensor, such as a fingerprint or facial recognition, PIN, pattern, voice recognition, or the like. According to examples of the passkey control center, users of a financial institution can select an account to sign into the financial institution platform without entering (e.g., typing) a username. The users can authenticate their identity (e.g., the owner of the account) using the user’s device screen lock, such as a fingerprint sensor, facial recognition, PIN, or the like. According to examples, once a passkey is created and registered with the passkey control center, the user can seamlessly switch to a new device and immediately use the new device to access the user’s account on the financial institution platform without needing to re-enroll (unlike traditional biometric authentication, which requires setup on each device).

However, users often encounter challenges in managing multiple passkeys across various devices and platforms, which underscores the necessity for a centralized management system. Existing decentralized systems for passkey management frequently lack user control and visibility, presenting limitations that can hinder effective passkey oversight. Existing passkey systems fail to provide users with granular control over how the user’s various passkeys are utilized for different authentication scenarios. Existing technologies further lack a centralized interface for users to view and manage all of their passkeys across different devices and cloud services. Additionally, existing authentication systems do not provide a way for users to set specific preferences for each passkey, such as restricting high-risk transactions to more secure device-bound passkeys. While passkeys can prove the validity of a user’s login credentials, passkeys do not confirm whether the person attempting to access the account is who they claim to be (e.g., the owner of the account). So, while passkeys might offer higher security than passwords, they can still be bypassed by savvy fraudsters. Fraudsters (e.g., a person or group that accessed the system by fraudulent attack, by illegal purchase of correct credentials, etc.) can continue to access secure accounts using phishing attacks, social engineering tactics, or other fraudulent attacks used to steal sensitive information like log-in credentials. As artificial intelligence and/or generative artificial intelligence makes it easier to commit sophisticated social engineering attacks, more organizations are adopting passkeys as a fraud prevention strategy, and while they can be an effective security measure, passkeys are still at risk for certain types of fraud and could impact customer experience in unintended ways.

While passkeys may provide users with a convenient and secure means for authentication, users may wish to control the manner in which each of their passkeys are used. Furthermore, users may desire to view and manage their various passkeys in a single location that is associated with the safety, security, insurance, and trust that comes from interacting with their financial institution. Current digital authentication mechanisms cause users to have a lack of granular control over how their various passkeys are utilized for different authentication scenarios. Additionally, current digital authentication mechanisms lack a centralized interface for users to view and manage all of their passkeys across different devices and cloud services that are being used for services within the financial institution. Furthermore, existing authentication systems do not provide a way for users to set specific preferences for each passkey, such as restricting high-risk transactions to more secure device-bound passkeys. Current systems often lack a unified interface for users to manage passkey preferences, leading to fragmented control and potential security vulnerabilities. Existing solutions fail to provide a comprehensive overview or allow for detailed configuration of authentication preferences. There is a need for a system that allows users to centrally manage their passkeys while providing granular control over how each passkey is used, particularly for sensitive financial transactions.

Example embodiments of the passkey control center presented throughout solve these issues and additional technical problems by offering a unified platform for passkey management, enabling users to configure detailed authentication preferences, and providing visibility into passkey usage across various financial activities. For example, the financial institution’s platform, e.g., website, application, etc., stores a “public” passkey, while a private key is stored on the customer’s device or password manager, so the customer of the financial institution can use the passkey to securely access their account. Passkeys are encrypted on both ends, so the customer can only access their account once their private key matches the site or application’s public key. Examples of the passkey control center address existing technological deficiencies by offering a centralized platform where users can view, manage, and configure passkey authentication preferences, thereby enhancing security and user convenience. Passkeys streamline multi-factor authentication (MFA) processes like two-factor authentication (2FA), aiming to complete those steps with a single action associated with the financial institution and/or third-party services associated with the financial institution. Once a passkey is set up with the financial institution authentication system by the customer, the customer can use this single action to log into their account moving forward. Examples of the passkey control center enable customers to use passkeys for secure authentication without requiring constant 2FA or MFA processes. In turn, the use of passkeys with the passkey control center described herein can significantly reduce customer friction when accessing the financial institution application (e.g., banking app). For example, as passkeys are mobile-friendly, meaning customers can use the same authenticator for their passkey as they use to unlock their device’s screen, the customer does not need multiple devices, codes, or other access points to securely log into their customer account.

Examples of the passkey control center described throughout address technical challenges by offering a centralized solution that consolidates passkey management, thereby enhancing user control and visibility of their digital security associated with the financial institution. Examples of the passkey control center provide for streamlined management of passkeys, enabling users to configure authentication preferences and monitor passkey usage across different platforms and devices that interact with the financial institution. By centralizing these functions, examples of the passkey control center not only simplify the user experience but also integrate advanced security measures to protect passkey data associated with high-risk banking and other financial services, thereby addressing the limitations of decentralized systems, and providing a comprehensive solution for modern digital authentication needs. According to examples, depending on what passkey type is chosen, customers may not need to type anything to log into their account, not even their username. For example, once the user’s device has been verified, a valid customer merely has to unlock their device and access their financial institution’s application in order to securely log in according to the customer preferences set in the passkey control center.

The combination of passkeys associated with customer preferences identified in the passkey control center helps customers avoid falsely triggering their financial institution’s fraud detection system with excessive password resets due to forgotten passwords or pin codes. Preventing fraud is a matter of adding the right amount of user friction to the banking experience. Passkeys can reduce customer friction while simultaneously making it harder for fraudsters to commit account takeover (ATO) fraud. Examples of the passkey control center further provide extra protection in the event of a data breach, as customers can use passkeys, which are unique to each site or application as opposed to passwords, which users may repeat across multiple services.

The passkey control center 104 serves as a comprehensive platform for centralized management of passkeys, facilitating user control over digital authentication processes. This system encompasses a backend engine that efficiently stores and manages user passkey preferences within individual user accounts. The backend engine is designed to interact with user devices to request and receive passkey indications, which include crucial data such as public keys, entity identifiers, and device identifiers. Upon receiving this information, the system generates detailed entries for each passkey, capturing the type of passkey, whether it is device-bound or synced, and other contextual details. Users are empowered through an intuitive interface to view and manage their passkeys, configure authentication preferences, and request deletions. This interface allows for the customization of authentication rules, providing users with the ability to define specific circumstances under which each passkey is utilized. Furthermore, the system is capable of disseminating instructions to associated entities and devices to ensure the implementation of user-defined preferences, thereby maintaining alignment with user expectations and enhancing security protocols. This structured approach not only simplifies the management of digital credentials but also bolsters security by ensuring that passkeys are used in accordance with user-defined parameters, thereby reducing the risk of unauthorized access.

Examples of the passkey control center described throughout can leverage machine learning (ML) applications (e.g., large language models, targeted/small language models, etc.) to enhance risk analysis and passkey selection functionality over time. Machine learning algorithms can analyze historical transaction patterns to identify anomalies and dynamically adjust risk levels, providing a more adaptive security approach. In examples of the passkey control center, ML models can learn from user behavior to suggest appropriate passkey selection based on contextual factors such as location, device, and time of day, enhancing the system’s ability to provide relevant authentication options. Additionally, machine learning can optimize the selection of additional authentication factors based on risk assessment and user preferences, implementing an adaptive multi-factor authentication system.

To further strengthen security measures, ML models incorporated into the passkey control center or otherwise implanted to be used with the passkey control center can be trained to detect potentially fraudulent activities and recommend stricter passkey requirements for suspicious transactions, adding an extra layer of protection against unauthorized access. Over time, machine learning algorithms can analyze individual user behavior and risk tolerance to suggest personalized passkey configurations, improving the overall user experience while maintaining robust security standards. ML applications can work in conjunction with the passkey control center’s features to create a more intelligent, responsive, and secure authentication system for financial transactions and account management.

In some examples, the passkey control center is integrated into digital platforms such as banking applications or other financial institution platforms, allowing users to manage their passkeys within the familiar environment of their financial services. This integration enables users to configure authentication preferences directly through the banking application, ensuring a cohesive user experience and an enhanced feeling of security. Additionally, examples can extend the functionality of the passkey control center to non-digital channels, such as ATMs, providing users with the ability to manage passkeys in physical locations. Such extensions of the passkey control center can prevent potential workarounds by offering comprehensive coverage across both digital and physical access points.

According to examples, the passkey control center can include managing passkeys for third-party services and aggregators, broadening the scope of passkey management to encompass a wider range of digital interactions. For example, the passkey control center can incorporate different cryptographic techniques, such as quantum-resistant algorithms, or explore varied user interface designs, ensuring the passkey control center remains adaptable and secure against evolving technological landscapes. These examples collectively enhance the versatility and resilience of the passkey control center in the technical field of digital authentication. Example embodiments further enable younger or technology-savvy users to engage in native platforms (e.g., mobile banking applications) using a passkey control center integrated in the native platform.

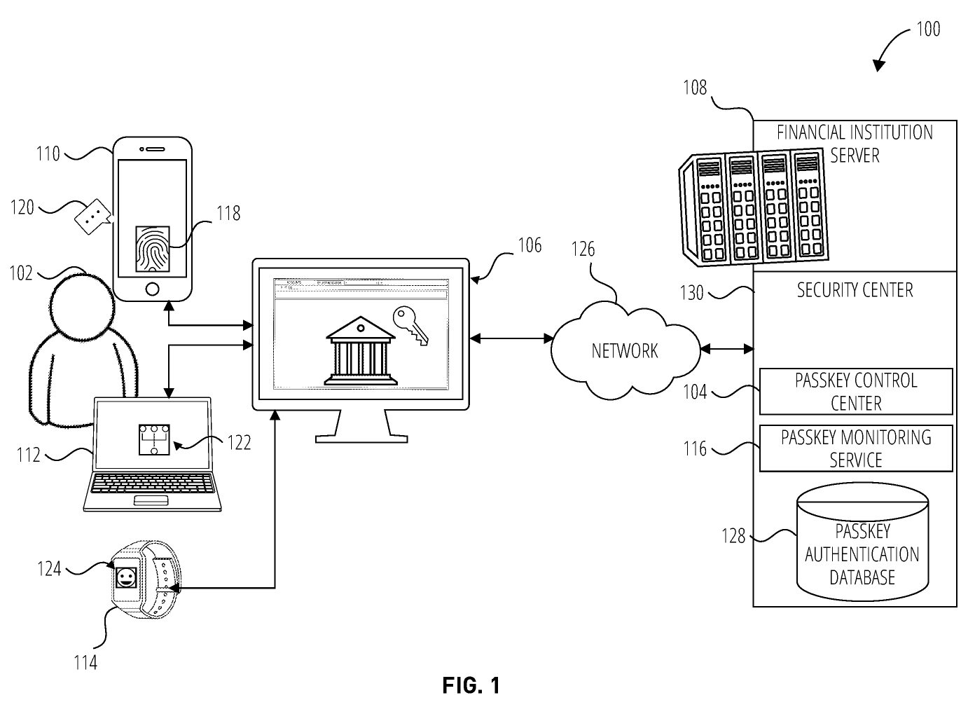

FIG. 1 illustrates an example network arrangement 100 of an example financial institution server 108 operatively connected to multiple user devices in accordance with examples. The network arrangement 100 is provided by way of example and not limitation, as a network arrangement of a given financial institution server 108 could have different numbers, types, and/or arrangements of devices, systems, networks, and/or the like. Moreover, the present disclosure is not limited in applicability to financial-services institutions, as embodiments of the present disclosure could be applied to many different types of organizations.

In the example network arrangement 100 depicted in FIG. 1, a number of different devices, systems, and the like are communicatively connected with a network 126 (e.g., the Internet) via respective communication links. The environment 100 comprises a customer 102, a passkey control center 104, a financial institution application web server 106, a financial institution server 108, a mobile device 110, a laptop device 112, and a smart watch 114. The financial institution server 108 may include one or more servers, such as a server hosting the app user database (not shown) and a server hosting the public key database or may include both databases on a single server.

In the example of FIG. 1, the passkey control center 104 is a passkey management console stored on a security center 130 of the financial institution server 108. The passkey control center 104 is provided, via a user interface, to the customer 102 of the financial institution. The passkey control center 104 is configured to receive customer preferences, restrictions, and/or other passkey management instructions from the customer 102 to identify the customer’s passkey types and/or passkey permissions associated with services and functions of the financial institution. The passkey control center 104 can receive identified biometric information associated with the customer 102, such as the customer’s fingerprints 118 entered into the mobile device 110, customer’s facial recognition 124 features entered into the smart watch 114, customer’s voice recognition 120 data entered into the mobile device 110, customer’s pattern 122 data entered into the laptop device 112, or other forms of identifying information to confirm that the customer 102 is associated with the devices and passkeys stored in the passkey authentication database 128 of the financial institution server 108. It is understood that various user devices can use a variety of customer identifying information, such as the fingerprints 118, voice recognition 120, patterns 122, facial recognition 124, or other information to confirm the identity of the customer 102.

FIG. 1 illustrates one example of an environment 100 for interfacing between a computing device and a user to receive passkey control management preferences of the customer 102. The environment 100 includes a graphical user interface (GUI) 132 on a financial institution application web server 106 that is served to one or more user computing devices associated with the customer 102. The user computing devices 110, 112, or 114 may be any suitable computing device or devices such as, for example, a smart phone, a tablet computer, a laptop computer, a smart watch, etc. User computing devices 110, 112, or 114 can comprise a display for showing the GUI 132 to the customer 102. In some examples, user computing devices 110, 112, or 114 execute a web browser application. The web browser application may communicate with the financial institution application web server 106 to receive the GUI 132 and display the GUI 132 at a screen or other display of the user computing device 110, 112, or 114. Although three user computing devices 110, 112, or 114 are shown in FIG. 1, in some examples, the customer 102 receives the GUI 132 at a single user computing device (e.g., one of 110, 112, or 114). In some examples, the customer 102 receives the GUI 132 at different user computing devices 110, 112, or 114 at different times.

The environment 100 also includes the financial institution server 108. The financial institution server 108 includes one or more computing devices that may be at a common geographic location or may be distributed across multiple geographic applications. The financial institution server 108 may receive data regarding one or more accounts held by the customer 102, for example, as described herein. The GUI 132 may be generated by any suitable combination of the financial institution server 108, the financial institution application web server 106, and/or the user computing device 110, 112, or 114. Also, in some examples, the financial institution application web server 106 is omitted and the user computing device(s) 110, 112, or 114 is served the GUI 132 directly by the financial institution server 108.

In examples of the environment 100, the passkey authentication database 128 may send an indication via the network 126 via the financial institution application web server 106 indicating that the customer device(s) 110, 112, or 114 or the customer 102 of the device(s) 110, 112, or 114 has an associated login or authentication (e.g., a username) stored in the financial institution server 108, such as in the security center 130 or other backend engine. This indication may be sent in response to a query from the financial institution application web server 106 (e.g., in response to the customer 102 asking the financial institution to initiate obtaining a passkey or in response to a communication, such as a proximity-based communication from the customer device(s) 110, 112, or 114 to a platform associated with the financial institution, such as an ATM or banker device associated with the financial institution. According to examples, the backend engine can also receive user device information from the user device that provided the passkey. For example, upon receipt of user passkey information, the backend engine can generate an entry within the user account for each received user passkey indication. Each entry can include an associated public key of the passkey, an entity identifier associated with the passkey, a device identifier of the user device that provided the passkey, an indication of whether the passkey is a device-bound passkey or a synced passkey, and/or other contextual details known by those having ordinary skill in the art.

The passkey control center 104 is composed of several components or otherwise operatively connected to components, including a centralized passkey management interface, a backend engine, a user account, and a user configuration interface. The centralized passkey management interface is configured as a primary point of interaction for users, allowing the users to view and adjust their passkey settings. The backend engine is configured for receiving and processing passkey data, generating entries for each passkey that include a public key, entity identifier, device identifier, and passkey type. The system’s backend engine facilitates the management of digital authentication by storing user passkey preferences and generating entries for each passkey indication received from a user device. These entries comprise a public key, an entity identifier, a device identifier, passkey type, and contextual details. An example includes a passkey control center interface that allows users to view and manage passkeys, configure authentication preferences, and establish rules for passkey usage. Additionally, the system provides instructions to associated entities or user devices to implement these preferences and offers an overview of passkeys linked to a user device or identity. It also handles passkey deletion requests by instructing entities to delete stored public keys and directing user devices or cloud services to remove copies of public and private keys. For example, users can manage these entries through their user account, which stores authentication preferences.

Examples include a passkey control center integrated within the security interface of a financial institution application. The passkey control center 104 enables users to view, manage, and set preferences for multiple passkeys associated with their financial accounts. Users can specify which passkeys can be used for specific types of financial activities, with options to restrict high-risk transactions to more secure device-bound passkeys. The passkey control center 104 can be implemented as a module or container within an existing security center of a financial institution application’s mobile application and online banking interface or otherwise be operatively interconnected to a financial institution application.

In examples, the passkey control center 104 can include a component maintaining a list of high-risk financial services and transactions, such as large money transfers or wire transfers, especially to international accounts, opening new accounts or adding new beneficiaries, changing critical account information (e.g., contact details, passwords), requesting loans or credit limit increases, initiating high-value investments or trades, accessing or modifying sensitive customer information, or the like. The high-risk services and/or high-risk transactions can be maintained by the financial institution as being designated high-risk, and/or the customer using the passkey control center 104 can designate some of the maintained list or additional or fewer services and/or transactions to be selected by the customer at a variety of risk levels. The variety of risk levels can require a variety of different sensitive transactions, enhanced security transactions, priority verification transactions, elevated protection activities, or the like that the customer can customize according to specific passkeys.

An authentication type can relate to a type of authentication that is necessary to engage use of the customer’s passkey to approve or initiate a financial institution service. For example, the initial authentication type can be a password, a pass phrase, a personal identification number (PIN), a biometric, or the like. In examples where the authentication type is a biometric that is used to engage use of the passkey, the authentication can include facial recognition of the customer 102 or an iris scan of the customer 102 where the device can have image capture capabilities that can capture facial features of the user or scan an iris of the user. The biometric can also include fingerprint recognition where the user can provide their fingerprint to an associated device. As the authentication type can be user selectable, a user associated with the device can select which type of authentication should be used to engage the passkey.

A passkey may include a private key of a private and public key pair. In the examples described herein, the passkey may be stored on the customer device 110, 112, or 114 and the public key may be stored at the financial institution server 108, for example in the passkey authentication database 128 or other database of the financial institution server 108. The public key may be encrypted before being stored in the financial institution server 108. The passkey may be generated at the financial institution application web server 106 or at a banker device (not shown) associated with the financial institution. In an example, one of the customer devices 110, 112, or 114 may communicate with the financial institution server 108. The communication may include a device-to-device direct communication, such as one that relies on proximity, for example NFC. In other examples, the communication may be over a network (e.g., the Internet). In response to receiving the communication from a customer device, the financial institution server 108 or component thereof may check credentials or authentication of the customer device or the customer 102 with the security center 130 or the financial institution server 108 generally. The financial institution server 108 may receive a passkey at a passkey monitoring service 116 or may generate a passkey locally at the passkey control center 104. The passkey monitoring service 116 can provide instructions to entities and devices operatively connected to the customer account to implement user-defined preferences associated with each passkey authenticated by the financial institution.

The passkey control center 104 can transmit (e.g., send) the passkey, for example via the Internet or NFC, to one or more of the customer device(s) 110, 112, or 114 for storage. When the passkey control center 104 is the device that generates the passkey, the passkey control center 104 may also generate a public key and send the public key to the passkey authentication database 128 for storage. While this procedure uses the network 126, it may be a network internal to the financial institution, and thus in an example, the passkey does not leave the ecosystem of the financial institution. The final transmission of the passkey to one or more of the customer’s device(s) 110, 112, or 114 may be done using proximity as a security measure, preventing man in the middle attacks.

According to examples, when the customer 102 wants to authenticate (e.g., to a banking app, financial institution platform), the customer 102, via one of the device(s) 110, 112, or 114 (e.g., as initiated by the app) may transmit a request encrypted via the passkey to the financial institution server 108. The financial institution server 108 may access the passkey authentication database 128 to decrypt the request. In some examples, after receiving a request from one of the customer device(s) 110, 112, or 114, the financial institution server 108 may send a response encrypted with the public key, decryptable at the respective customer device using the passkey. In an example, when the customer 102 enters a branch associated with the financial institution, the customer 102 may request a passkey (e.g., the customer may verbally request a passkey from a banker, or a customer device associated with the customer 102 may send a request to the financial institution server 108 or to a banker device). In response to the request, the financial institution server 108 may authenticate the customer 102 or one or more of the customer device(s) 110, 112, or 114 (e.g., via receiving authentication verification from the financial institution server 108 or elsewhere). The financial institution server 108 may verify or receive a verification that the customer 102 is a registered mobile user, in some examples. The financial institution server 108 may generate a passkey paired to one or more of the customer device(s) 110, 112, or 114 and, optionally, to an account associated with the customer 102. The verified customer device may then communicate with the financial institution server 108. Once verified, a passkey may be transmitted to one or more of the customer device(s) 110, 112, or 114.

Once the customer device(s) is verified, when the customer 102 performs a transaction on one of the customer device(s) 110, 112, or 114, the experience may be seamless, for example passing the passkey without the customer directly involved (e.g., automatically, without entering a login name, without customer action, etc.). When the customer 102 attempts to perform a transaction on a different device (e.g., website accessed on a different computing device), an additional query may occur (e.g., to the customer device 112). For example, the customer 102 may attempt a transaction on a separate device and receive a confirmation request on the customer device 112. In response to confirming the request on the customer device 112, the passkey may be used to verify a portion of the transaction automatically. The passkey stored on the customer device 112 may be secured by one or more device-based security measures on the customer device 112. For example, the passkey may be only activated by a password, biometric, gesture, etc. (or a combination) at the customer device 112.

In examples, the passkey control center 104 enables users to manage their passkeys via a centralized, trusted location in a financial institution server 108, which offers functionalities such as storing and managing user passkey authentication preferences within an associated customer account and enabling customers to configure authentication preferences for each passkey, thereby defining rules for each passkey usage and/or for each service or context provided by the financial institution. The passkey control center 104 generates entries for each passkey received, including details like the public key, entity identifier, device identifier, and/or the passkey type (e.g., device-bound or synced). The passkey control center 104 provides an overview of passkeys associated with a user device and/or identity, and managing these for various entities, including deletion requests. The passkey control center 104 enables the customer 102 to utilize one or more passkeys to serve as digital substitute(s) for passwords, providing a more secure and more convenient method of digital user authentication. The passkey control center 104 allows for multiples passkey types, such as passkeys that can be device-bound, meaning they are tied to a specific customer device, such as the user’s mobile device 110 and cannot be transferred or used on another device or passkeys can be synced across multiple devices, such as the user’s laptop device 112 and/or the user’s smart watch 114, which allows for flexible user authentication across different platforms and environments.

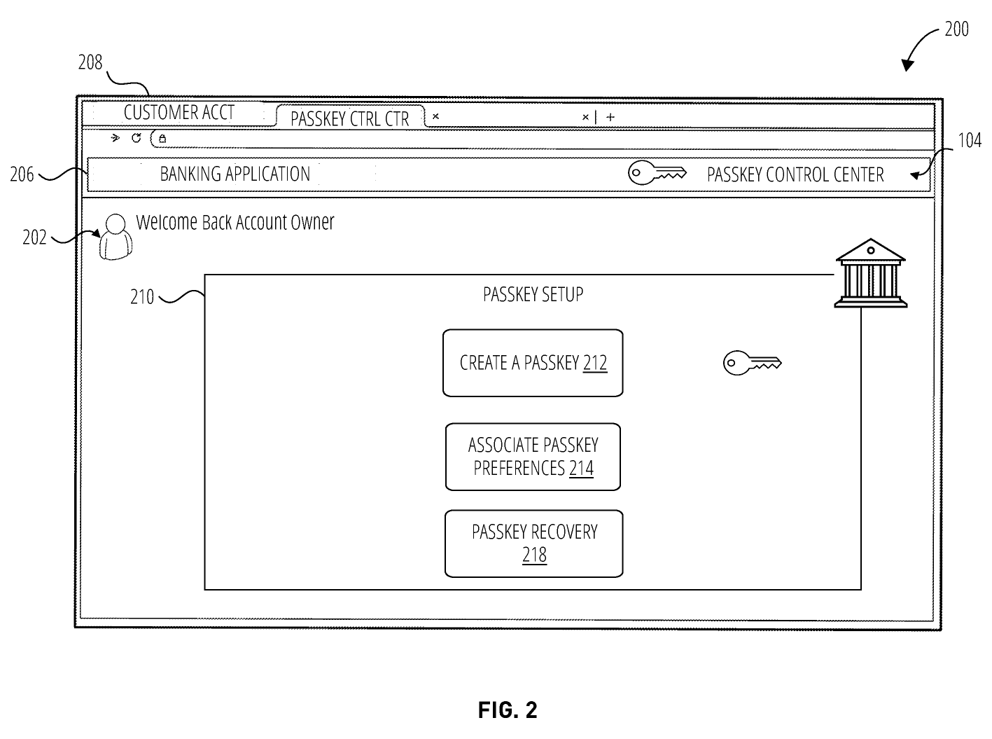

FIG. 2 illustrates a block diagram 200 of an example graphical user interface (GUI) to enable a financial institution customer to setup a passkey using the passkey control center 104 including passkey preferences 214 in accordance with some examples.

To create a passkey for a website or application, such as a banking application, a user first must register with the banking application. The user, such as the account owner 202, is instructed to go to the banking application and sign in using an existing sign-in method, followed by instructions to click a “create a passkey” button 212 provided on the block diagram 200 for the passkey control center 104. The passkey control center 104 confirms that the user’s information associated with the user’s account with the banking application is associated with the user’s new passkey. Once confirmed by the passkey control center 104, the user can use any of their device’s screen unlock methods to create the passkey (e.g., PIN, facial recognition, fingerprint, etc.)

Once the passkey setup 210 is completed in the passkey control center 104, when the user returns to banking application to sign in a next time, the user need only take the following steps: (1) Go to the banking application, (2) Tap on the account name field to show a list of passkeys in an autofill dialog, (3) Select the user’s associated passkey, and (4) Use the device screen unlock to complete the login. According to examples of the passkey control center, the user’s device then generates a signature based on the passkey. This generated signature is used to verify the login credential between the origin and the passkey, therein granting the user access to their banking account. After the passkey setup 210 is completed, the user can click on a “associate passkey preferences” button 214 to identify which passkey functions can be used for different services on the banking application.

Once a passkey is created and registered, the user can seamlessly switch to a new device and immediately use the new device to access the banking application without needing to re-enroll the new device (unlike traditional biometric authentication, which requires setup on each device). A user can sign into services on any device using a passkey, regardless of where the passkey is stored. For example, a passkey created on a user’s mobile phone can be used to sign into a website on a user’s laptop. According to examples of the passkey control center, users are not restricted to using the passkeys only on the device where the passkey is available. For example, passkeys available on a user’s phone can be used when logging into the application using the user’s laptop, even if the passkey is not synchronized to the user’s laptop, as long as the phone is near the laptop and the user approves the sign-in on the phone.

Examples of the passkey control center 104 implements enhanced security measures for accessing the passkey control center itself; for example, including multi-factor authentication or higher security thresholds. The passkey control center 104 includes continuous monitoring and controls that are implemented to ensure adherence to user-set preferences for use or disuse of passkeys and detection of any unauthorized access or changes to the customer account 208. The passkey control center 104 maintains adherence to user preferences 214 without automatic fallback to less secure methods when preferred authentication is unavailable. Alternative recovery methods are provided through other channels (e.g., branch visits, call centers, etc.) for account recovery, passkey recovery 218, or creating new device-bound passkey(s) in case of device loss.

Examples of the passkey control center can manage edge cases, such as a user losing access to their registered devices, in several ways including alternative authentication channels, recovery processes, backup passkeys, tiered access recovery, multi-factor recovery, or the like. For example, the passkey control center can implement alternative authentication channels to provide alternative authentication methods through other secure channels, such as in-person verification at bank branches or through a secure call center. The passkey control center recovery process can implement a recovery process that allows users to create new device-bound passkeys or regain access to their account.

Passkeys were created to be a technology-agnostic security solution. But today’s customers might not actually be able to use passkeys universally across every device because passkeys often create vendor locks. For example, if a customer creates their passkey on an iPhone®, the customer will not be able to use the same passkey on their Microsoft® laptop. These devices use different operating systems (e.g., iOS® and Windows®, respectively), which have their own encryption algorithms. According to examples, the passkey control center can include a backup passkey option for users to set up multiple passkey types, including both device-bound and synced passkeys, to provide redundancy in case of device loss. The passkey control center’s ability to manage multiple passkey types enables users to have a first passkey for their iCloud® account that is a synced passkey, a second passkey for their Google Cloud® account that is a synced passkey, and a third passkey for their iPhone® that is a device-bound passkey.

The passkey control center can include a tiered access recovery process where users can regain limited access to their account using lower-security methods. When less secure methods of recovery are used to recover the user’s passkey, the passkey control center can require the user to complete a more rigorous verification process to regain full access or perform high-risk transactions. Additional examples of the passkey control center recovery process can include a multi-factor recovery process that utilizes multiple factors for verification, such as combining knowledge-based authentication (e.g., security questions), possession-based authentication (e.g., verification codes sent to alternate devices or email), identity verification (e.g., government-issued ID), combinations of multiple verification requirements, or the like. These approaches help ensure that users can regain access to their accounts and passkeys via the passkey control center even if the user loses access to their registered devices, while maintaining the security and integrity of the passkey control center.

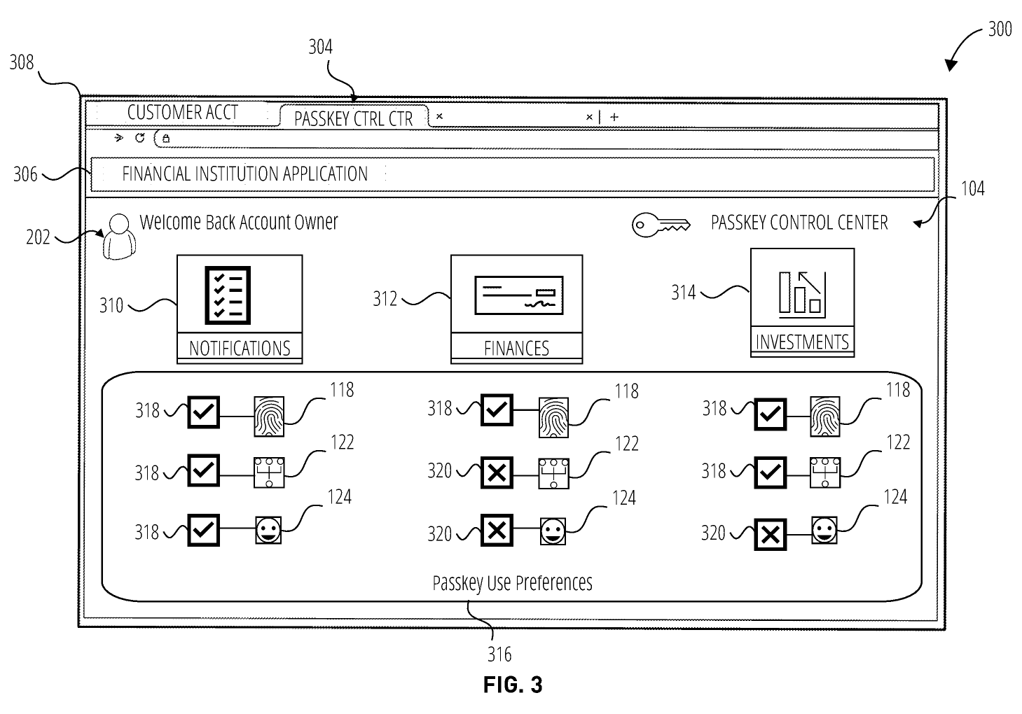

FIG. 3 illustrates a block diagram 300 of an example graphical user interface (GUI), such as the GUI 132 as described and depicted in connection with FIG. 1, including passkey use preferences 316 in accordance with some examples. The block diagram 300 illustrates the passkey control center 104 as a customer management console of the financial institution application that enables a customer, such as an account owner 202, to specify and organize the customer’s passkey use preferences 316.

For example, the passkey control center tab 304 of a web browser 308 displays the passkey use preferences 316 available to the account owner 202. The account owner 202 can choose specific passkey use preferences for different services provided by the financial institution. For example, the account owner 202 can identify specific passkey uses for notifications 310, finances 312, and investments 314. According to the example for allowing passkeys to be used to receive notifications 310, the account owner 202 has selected to allow passkey usage for fingerprints 118 by selecting the check mark 318 next to the fingerprints 118 icon. The account owner 202 has further allowed passkeys to be used to receive notifications 310 by entering the pattern 122 and employing facial recognition 124 by similarly selecting the check marks 318 next to the pattern 122 icon and the facial recognition 124 icon.

However, for the account owner 202 has elected different passkey preferences for higher-value financial activities, such as what passkeys can be used for finances 312. According to the example for user passkey preferences to be used to view or changes the account finances 312, the account owner 202 has selected to only allow passkey usage for fingerprints 118 by selecting the check mark 318 allow passkey usage next to the fingerprints 118 icon, and the account owner 202 has expressly rejected passkey usage when entering the pattern 122 or the facial recognition 124 by selecting the x marks 320. Additionally, the account owner 202 has selected to allow use of passkeys to access the account finances 312 using either or both fingerprints 118 and pattern 122 entry by selecting the check marks 318 next to the fingerprints 118 icon and the pattern 122 icon but has rejected the use of passkeys to access account investments 314 by selecting the x mark 320 next to the facial recognition 124 icon.

According to examples of the passkey control center 104, account owners or authorized users of an account may prioritize higher value activities within the financial institution platform as preferential or more sensitive, by requiring more personal or secure biometrics (e.g., fingerprints 118) to access certain services or areas of the financial institution. For example, finances 312 may be prioritized by the account owner 202 (or authorized user) to identify actions on the financial institution platform that can only be taken using the most individualistic or secure biometrics available on the passkey control center.

Examples presented herein include the passkey control center 104 that provides users with a unified platform for passkey management, enabling users to configure detailed authentication preferences, and providing visibility into passkey usage across various financial activities associated with a financial institution. The technical solution includes the passkey control center 104 that allows users to individually manage each associated passkey in a common location, such as a secure server of the financial institution. Examples of the passkey control center 104 provide a system for centralized passkey management and include a centralized passkey management interface and a backend engine to ensure the account owner 202 passkey preferences are considered before any financial institution service or action is performed.

Examples of the backend engine, such as the security center 130 described and depicted in connection with FIG. 1, are configured to receive and process passkey data, generate entries for each passkey, monitor for changes in customer passkey preferences, and adjust entries based on detected changes. A user account can store and manage passkey authentication preferences. A user configuration interface can display an overview of passkeys associated with the customer’s account and enable setting of authentication preferences on a per-passkey, per-passkey type, or per financial service option. The authentication preferences for passkey usage can also be maintained for secure access to certain customer account information using passkeys that are available to authorized users of the account, such as family members that have access to the same customer devices. For example, if a husband and wife share a tablet computer with their children, and the table computer has access to the financial institution application 306, the parents may desire to block passkey usage associated with pattern 122 data and facial recognition 124 entries because their children may have access to those biometrics of codes. Whereas the parents may desire to allow passkey usage associated with fingerprints 118, which the children will not be able to provide even when using the same customer device (e.g., the same shared tablet).

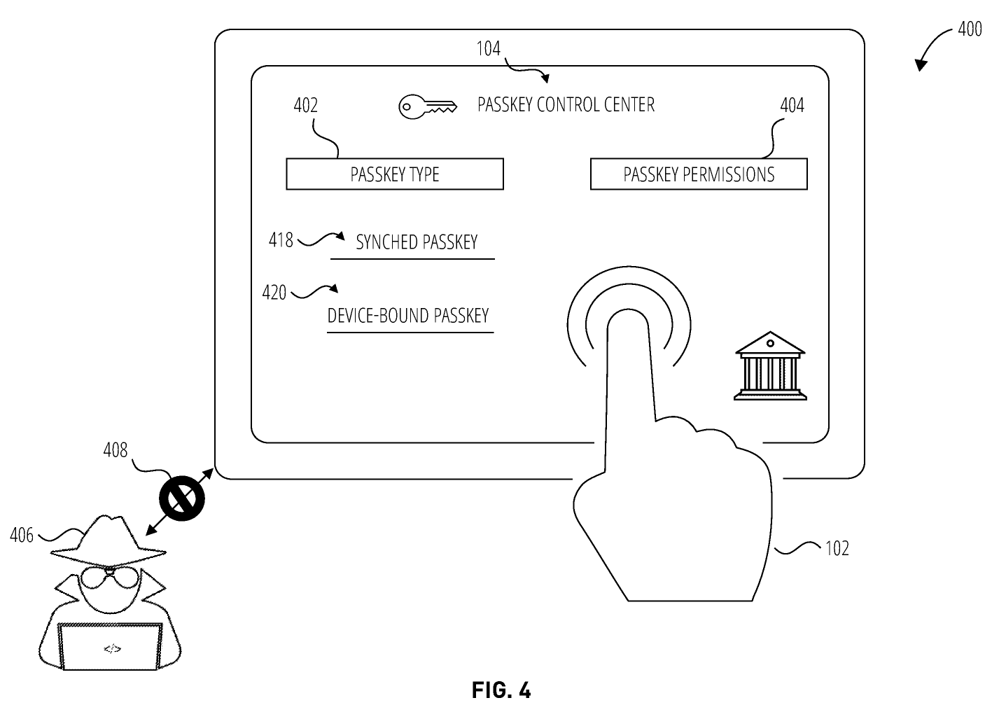

FIG. 4 illustrates a block diagram 400 of an example graphical user interface (GUI) including the passkey control center 104 to enable a financial institution customer to setup a passkey type 402 and passkey permissions 404 in accordance with some examples. The block diagram 400 comprises the customer 102 interacting with the passkey control center 104.

In examples, the customer can identify what actions within the financial institution platform can be taken according to different levels of authentication using device-bound passkeys 420 and cloud-synched passkeys 418. Examples of the passkey control center 104 can be configured to manage multiple passkeys across various platforms and devices associated with the financial institution or operatively connected to the financial institution using the passkeys in the passkey control center 104.

According to examples, the passkey control center 104 can store and manage a user’s passkey authentication preferences within an associated user account. In examples, a backend engine can request an indication of the user’s passkeys from a user device. The indication of a user’s passkey may be the public key of a passkey and/or an entity identifier associated with the passkey. In some examples, the indication of user’s passkey can include, for example, a device identifier, a biometric data hash, passkey usage metadata, a user account identifier, a cryptographic token, or the like. The device identifier can be the indication of the user’s passkey since the system supports device-bound passkeys, and the unique identifier of the user’s device could serve as an indication of the associated passkey.

In examples, a biometric data hash can be the indication of the user’s passkey for passkeys that use biometric authentication, and a secure hash of the user’s biometric data (e.g., fingerprint or facial recognition) can be used as an indicator, without storing the actual biometric information. In some examples, the cryptographic token can be the indication of the user’s passkey because a unique cryptographic token generated for each passkey could serve as an indication, providing a secure and randomized identifier. In examples, the user account identifier can be the indication of the user’s passkey since passkeys are associated with user accounts, and a unique identifier for the user’s account within the financial institution’s system can be used to indicate associated passkeys. In some examples, the passkey usage metadata can be the indication of the user’s passkey because information about how and when the passkey is typically used (e.g., frequency of use, types of transactions) could serve as a supplementary indicator, helping to distinguish between multiple passkeys associated with a single user.

According to examples, once a passkey entry is added to the customer account, the user may view and manage their passkeys within the passkey control center 104. In particular, the user may configure passkey authentication preferences for each individual passkey entry. For example, a passkey authentication preference may define a rule for the circumstances in which the passkey is to be used. For example, a user may be aware of what devices are connected to customer cloud accounts, and the user can determine that they are comfortable with certain services of the financial institution being associated with or used with a cloud-synched passkey 418. In other situations, the user may determine that certain services provided by the financial institution that are of higher-concern to the user, such as changing customer information, transferring funds, opening accounts, or the like, should only be connected to the customer’s device-bound passkey 420. For example, any passkey permissions 404 associated with transferring money out of a customer account must use the customer’s device-bound passkey 420, which may require the user’s fingerprint to be entered onto the user’s mobile device in order to ensure additional levels of information and security are provided to the customer.

In examples, a passkey authentication preference for a first passkey entry that corresponds to a synced passkey may require that this passkey be used by default when logging into an associated online portal for the associated entity. A passkey authentication preference for a second passkey entry that corresponds to a device-bound passkey for the same entity may require that this passkey should only be used upon specific user request. As such, the user may control the manner in which each passkey is used with an entity. The backend engine may provide instructions to an associated entity and/or user device to implement these passkey authentication preferences.

In examples, the passkey control center may provide the user with an overview of the passkeys currently associated with an associated user device and/or user identity. The user may manage their passkeys for various entities within the passkey control center 104. For example, the user may request that a passkey associated with an entity be deleted, modified, or otherwise used for specific circumstances. The passkey control center may then instruct the associated entity to delete the stored public key of the passkey and may instruct the user device and/or an associated cloud service to delete copies of the public and private key.

In examples, the passkey control center 104 can include a passkey type 402 that comprises a device-bound passkey 420 or a cloud-synced passkey 418. The user configuration interface can enable setting of authentication preferences based on transaction risk levels. Authentication preferences can include, for example, specifying allowed methods for device-bound passkeys and defining usage contexts for synced passkeys. An implementation module can enforce stricter authentication requirements for high-risk transactions. A backend engine can verify the authenticity and integrity of passkey data before generating entries. The passkey control center can implement homomorphic encryption for secure computation on passkey data and zero-knowledge proofs for verifying authenticity without exposing the passkey. Quantum-resistant algorithms can ensure long-term security. The centralized passkey management interface can require additional authentication, such as multi-factor authentication, for access. Alternative recovery methods can be provided for creating new device-bound passkeys in case of device loss.

According to examples of the passkey control center 104 described throughout can provide additional access control and security measure that can be implemented in or connected to the passkey control center including tiered access levels, behavioral biometrics, geolocation-based restrictions, time-based access controls, audit logging and alerts, or the like. For example, tiered access levels can be implemented as different levels of access within the passkey control center, requiring progressively stronger authentication for more sensitive operations like changing high-risk transaction settings. Behavioral biometrics can be incorporated in the passkey control center enabling analysis to continuously verify the user’s identity based on factors like typing patterns or device handling. Geolocation-based restrictions can be integrated into the passkey control center to allow users to set geographic restrictions on passkey usage, enhancing security for international transactions. In examples, time-based access controls can be included in the passkey control center to enable users to set time-based restrictions on passkey usage, such as limiting high-risk transactions to business hours. Audit logging and alerts can be implemented in the passkey control center to enable comprehensive logging of all activities within the passkey control center and provide real-time, near real-time, or otherwise set alerts for suspicious actions.

Examples of the passkey control center 104 serve as a centralized interface that facilitates the management of passkey authentication preferences, providing users a streamlined approach to overseeing their digital credentials. The user configuration interface provides a comprehensive overview of passkeys associated with user devices or identities, enabling users to set authentication preferences tailored to each passkey. Examples of the passkey control center 104 process passkey data by generating entries and allowing users to configure authentication preferences and the passkey permissions 404, which can then be implemented across various platforms and devices. The passkey control center 104 can include the ability to manage passkeys across multiple platforms and devices, as well as the integration of advanced cryptographic techniques, such as homomorphic encryption and zero-knowledge proofs, to ensure the security of passkey data. This approach enhances the security and flexibility of passkey management, providing users with a robust tool for digital authentication.

The passkey control center 104 can recognize multiple types of passkeys. For example, the passkey control center can recognize synced passkeys, which include digital keys stored in cloud services (e.g., iCloud®) that can be accessed from multiple devices connected to the user’s cloud account, and device-bound passkeys, which include unique to (and stored only on) a specific device, providing higher security by limiting access to a single device.

Examples of the passkey control center provides functionalities such as passkey visibility and management, authentication preference configuration, use case configuration, or the like. For example, the passkey control center 104 functionality enables passkey visibility and management to allow users to view all of their passkeys in one place that are associated with the financial institution, including information about each passkey’s type (e.g., synced, device-bound, etc.) and associated accounts. The authentication preference configuration enables users to set preferences for how each passkey is accessed. For example, for device-bound passkeys 420, users can specify which authentication methods are allowed (e.g., biometrics only, device PIN, etc.). The passkey control center functionality enabling use case configuration provides users with the ability to specify which passkeys should be used for different types of actions or transactions, allowing users to have granular control over security levels for various activities.

For example, the passkey control center 104 can be used by a customer having a high-yield savings account at a bank and a checking account at a credit union. Both platforms use passkeys, so the customer creates one passkey for each account and stores them using a password manager. Even though the customer’s passkey for their bank account is different from the customer’s passkey for their credit union, the customer can use facial recognition to access both accounts. If, for example, a data breach occurred at the financial institution, even if fraudsters were able to obtain sensitive information about this particular customer, the fraudster still cannot access the customer’s account without the customer’s passkey. Furthermore, fraudsters cannot use any stolen sensitive data to manipulate their way into the customer’s account because passkeys are not stored in financial institution’s databases like passwords, so hackers cannot steal or guess a passkey with the same ease that they can steal or guess a password.

Even if the hackers can answer knowledge-based authentication (KBA) questions on the financial institution’s platform or from a customer service representative, a passkey is not as easy to reset as a password. Even encrypted password managers are not immune to data breaches, where encrypted copies of password vaults and other Personally Identifiable Information (PII) can be stolen by fraudsters. While it is still possible for passkeys to be stolen and then reset—for example, by stealing someone’s device—passkeys widen the barrier to entry for hackers. As a result, passkeys used in examples of the passkey control center offer greater protection against data breaches than passwords.

Some fraudsters 406 are sophisticated enough to use AI to replicate a boss or loved one’s voice (known as voice phishing or vishing) or create lookalike websites. In circumstances like these, examples of the passkey control center 104 employing passkeys for their customers still act as a barrier 408 to account access. If the fraudster 406 is not using the customer’s device tied to the passkey, they are unlikely to gain access despite their efforts to manipulate the customer. Examples of the passkey control center 104 provide additional security to PII and customer account information because platform developers only save a public key to the financial institution server (instead of a customer’s password), meaning there is far less value for a bad actor to hack into financial institution servers. Examples of the passkey control center 104 employing passkey mechanisms, such as fingerprint sensors and facial recognition, significantly reduce the potential attack surface and mitigate the risk of unauthorized access. In the event of a security breach, the cryptographic nature of examples of the passkey control center and methods used in the passkey control center substantially diminish the need for extensive post-incident data sanitization and system remediation procedures that would otherwise be necessary if passwords were used instead of passkeys.

Examples of the passkey control center 104 can further help prevent credential-stuffing, which typically occurs when fraudsters manage to steal a large number of passwords. They then systematically try to use these credentials across a wide variety of sites and applications, hoping to gain access. The logic behind credential-stuffing attacks is that customers will often reuse passwords on multiple accounts because that one password is easy to remember. However, according to examples of the passkey control center 104 provided herein, credential-stuffing attacks simply do not work when a financial institution platform employing a passkey control center 104 using passkeys to replace passwords is used by the customer.

Passkeys are a safer and easier alternative to passwords. According to examples, passkeys used in the passkey control center of a financial institution platform enable users to sign into applications and websites with a biometric sensor (e.g., a fingerprint, facial recognition, etc.), PIN, or pattern, freeing the customer from having to remember and manage passwords. A passkey used according to examples of the passkey control center 104 can meet multifactor authentication requirements in a single step, which replaces both a password and a One-Time Password (OTP) (e.g., 6-digit SMS code, email code, phone call, etc.) to deliver robust protection against phishing attacks and avoid the user experience pain of SMS or app-based OTPs. Examples of the passkey control center employing passkeys are standardized, meaning a single implementation enables a password-less experience across all of a users’ devices, including across different browsers and operating systems. Examples of the passkey control center 104 employing passkey types with customer-specified passkey permissions associated with (e.g., assigned to each passkey or passkey type) additionally protect users from phishing attacks because passkeys only work on their registered websites and applications; a user cannot be tricked into authenticating on a deceptive website because the browser or operating system handles verification. Examples of the passkey control center 104 employing passkeys additionally reduce financial costs for sending SMS for OTP or authentication purposes, making passkeys a safer and more cost-effective means for two-factor authentication.

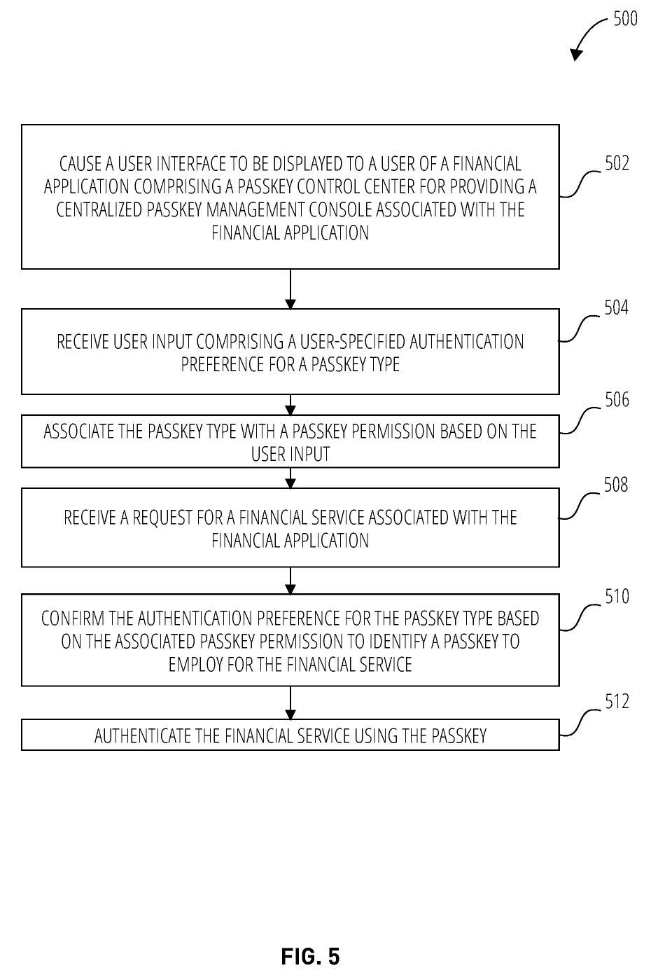

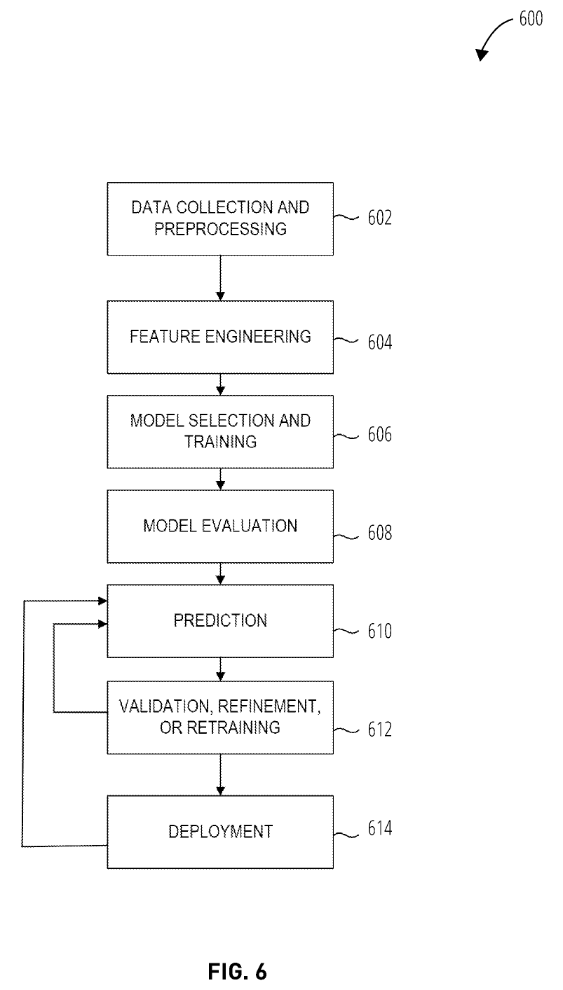

FIG. 5 illustrates a flow diagram of a method 500 for securely managing a passkey associated with a financial institution according to a customer’s passkey preferences, according to some example embodiments. The method 500 can be embodied in machine-readable instructions for execution by one or more hardware components (e.g., one or more processors, one or more hardware processors) such that the operations of the method 500 can be performed by components of the systems depicted in FIGS. 1–3 and/or FIGS. 6–8, such as the passkey control center 104 or the security center 130. Accordingly, the method 600 is described below, by way of example with reference to components of the security center 130. However, it shall be appreciated that method 500 can be deployed on various other hardware configurations and is not intended to be limited to deployment within the hardware of examples presented herein.

Depending on the example embodiment, an operation of the method 500 can be repeated in different ways or involve intervening operations not shown. Though the operations of the method 500 can be depicted and described in a certain order, the order in which the operations are performed may vary among embodiments, including performing certain operations in parallel or performing sets of operations in separate processes. While the various operations in this flowchart are presented and described sequentially, one of ordinary skill will appreciate that some or all of the operations may be executed in a different order, be combined or omitted, or be executed in parallel.

At operation 502, the security center 130 causes a user interface to be displayed to a user of a financial application comprising a passkey control center for providing a centralized passkey management console associated with the financial application. At operation 504, the security center 130 receives user input comprising a user-specified authentication preference for a passkey type. At operation 506, the security center 130 associates the passkey type with a passkey permission based on the user input. At operation 508, the security center 130 receives a request for a financial service associated with the financial application. At operation 510, the security center 130 confirms the authentication preference for the passkey type based on the associated passkey permission to identify a passkey to employ for the financial service. At operation 512, the security center 130 authenticates the financial service using the passkey.

Examples include identifying the passkey preferred by the customer and ensuring that the properly identified passkey is used for user-specified services or transactions based on the passkey control center monitoring. Example methods further include conforming with the user-specified preferences based on monitoring of changes to the passkey control center, such as passkey types, times of day or periods when certain passkeys are preferential according to the user, and other user actions associated with the passkey. A passkey is a modern authentication method that serves as an alternative to traditional passwords, using public key cryptography to provide a more secure and user-friendly way of accessing accounts and devices. Passkeys typically consist of two parts: a private key stored securely on the user’s device and a public key stored on the service provider’s server. When a user attempts to log in, the service sends a challenge to the user’s device, which then uses the private key to sign this challenge, creating a unique response that proves the user’s identity without transmitting the actual private key. Key features of passkeys include enhanced security, as they are resistant to phishing, password reuse, and server breaches; improved user experience, as there is no need to remember complex passwords; cross-device compatibility, allowing them to be synced across multiple devices securely; and biometric integration, often used in conjunction with fingerprint or facial recognition. Passkeys are being adopted by major technology companies and platforms as a more secure alternative to traditional password-based authentication. The concept of passkeys emerges as a contemporary alternative to traditional passwords, offering a sophisticated approach to enhancing digital security. To log into an account of a financial institution platform with a passkey, a user can use a biometric sensor, like a fingerprint or facial recognition, or enter a personal identification number (PIN). Passkeys, unlike static passwords, utilize, for example, cryptographic keys that provide dynamic and robust authentication mechanisms. A passkey is a password-less login method that aims to add extra security to digital banking accounts or other financial institution platforms.

The centralized system provides a streamlined approach to passkey management by providing users with a singular interface associating their passkeys and their financial institution(s), which simplifies the process of overseeing multiple passkeys across various devices and platforms. This consolidation allows users to manage their digital credentials efficiently, reducing the complexity associated with handling disparate systems. Enhanced security measures, such as homomorphic encryption and zero-knowledge proofs, are integrated into the system to safeguard passkey data. These cryptographic techniques enable secure computations and verifications without exposing sensitive information, thereby fortifying the system against potential breaches.

Furthermore, the passkey control center 104 enables users to have increased confidence and empowerment in their passkey by allowing users to enforce personalized authentication preferences, a feature that traditional methods lack. The personalized authentication preferences capability grants users greater control over their security settings, enabling them to tailor authentication processes to their specific needs and risk levels. The passkey control center’s architecture is designed to be scalable and flexible, capable of managing a large volume of passkeys without compromising performance. The scalable and flexible architecture ensures that as the number of users and devices grows, the passkey control center maintains its efficiency and reliability, making it a robust solution for modern digital authentication challenges.

The implementation of passkeys represents a significant advancement in authentication technology, offering enhanced security and user convenience compared to traditional password-based systems. Passkeys utilize public key cryptography to generate unique cryptographic key pairs for each user account, eliminating the need for users to memorize complex alphanumeric sequences. Authentication is facilitated through biometric methods such as fingerprint or facial recognition, leveraging the security features of modern devices. This technology is designed for cross-platform compatibility, functioning seamlessly across various operating systems, browsers, websites, and applications. This integration enhances the user experience by providing a consistent and secure authentication method across a wide range of mobile applications. Passkeys offer robust security features that make them resistant to common attack vectors. The cryptographic nature of passkeys renders them impervious to guessing attempts and immune to reuse attacks, significantly mitigating the risk of unauthorized access. Furthermore, passkeys are intrinsically linked to the specific application or website for which they were created, preventing phishing attacks by ensuring that users cannot inadvertently use their passkey on fraudulent platforms.

The following, non-limiting examples, detail certain aspects of the present subject matter to solve the challenges and provide the benefits discussed herein, among others.

Example 1 is a system for managing digital authentication in a financial application, the system comprising: one or more hardware processors of a machine; and at least one memory storing instructions that, when executed by the one or more hardware processors, cause the system to perform operations comprising: causing a user interface to be displayed to a user of the financial application, the user interface comprising a passkey control center for providing a centralized passkey management console associated with the financial application; receiving, via the user interface, user input, the user input comprising a user-specified authentication preference for a passkey type; associating the passkey type with a passkey permission based on the user input; receiving, via the user interface, a request for a financial service associated with the financial application; confirming the user-specified authentication preference for the passkey type based on the passkey permission to identify a passkey to employ for the financial service; and authenticating the financial service using the passkey.

In Example 2, the subject matter of Example 1 includes, the operations further comprising: monitoring a financial transaction to confirm conformance to the user-specified authentication preference for the passkey.

In Example 3, the subject matter of Example 2 includes, the operations further comprising: determining a risk level of the financial transaction based on the user-specified authentication preference; and selecting a corresponding passkey based on the user-specified authentication preference and the risk level of the financial transaction.

In Example 4, the subject matter of Examples 1–3 includes, wherein the passkey type comprises one of a device-bound passkey or a cloud-synced passkey.

In Example 5, the subject matter of Example 4 includes, wherein the user-specified authentication preference includes: identifying an allowed authentication method for the device-bound passkey.

In Example 6, the subject matter of Examples 4–5 includes, the operations further comprising: defining a usage context for the cloud-synced passkey to be used within the financial application based on a contextual factor.

In Example 7, the subject matter of Examples 4–6 includes, the operations further comprising: identifying a high-risk financial service; and restricting the high-risk financial service to the device-bound passkey.

In Example 8, the subject matter of Examples 1–7 includes, the operations further comprising: monitoring the passkey control center for types of transactions comprising low-risk activities; and suggesting a change to the passkey type based on the monitoring.

In Example 9, the subject matter of Examples 1–8 includes, wherein the passkey control center is implemented as a container within a security center of the financial application.

Example 10 is a method for managing digital authentication in a financial application, the method comprising: causing a user interface to be displayed to a user of the financial application, the user interface comprising a passkey control center for providing a centralized passkey management console associated with the financial application; receiving user input, the user input comprising a user-specified authentication preference for a passkey type; associating the passkey type with a passkey permission based on the user input; receiving a request for a financial service associated with the financial application; confirming the user-specified authentication preference for the passkey type based on the passkey permission to identify a passkey to employ for the financial service; and authenticating the financial service using the passkey.

In Example 11, the subject matter of Example 10 includes, monitoring a financial transaction to confirm conformance to the user-specified authentication preference for the passkey.

In Example 12, the subject matter of Example 11 includes, determining a risk level of the financial transaction based on the user-specified authentication preference; and selecting a corresponding passkey based on the user-specified authentication preference and the risk level of the financial transaction.

In Example 13, the subject matter of Examples 10–12 includes, wherein the passkey type comprises one of a device-bound passkey or a cloud-synced passkey.

In Example 14, the subject matter of Example 13 includes, wherein the user-specified authentication preference includes: identifying an allowed authentication method for the device-bound passkey.

In Example 15, the subject matter of Examples 13–14 includes, defining a usage context for the cloud-synced passkey to be used within the financial application based on a contextual factor.

In Example 16, the subject matter of Examples 13–15 includes, identifying a high-risk financial service; and restricting the high-risk financial service to the device-bound passkey.

In Example 17, the subject matter of Examples 10–16 includes, monitoring the passkey control center for types of transactions comprising low-risk activities; and suggesting a change to the passkey type based on the monitoring.

In Example 18, the subject matter of Examples 10–17 includes, wherein the passkey control center is implemented as a module within a security center of the financial application.

Example 19 is a non-transitory machine-storage medium embodying instructions for managing digital authentication in a financial application that, when executed by a machine, cause the machine to perform operations comprising: causing a user interface to be displayed to a user of the financial application, the user interface comprising a passkey control center for providing a centralized passkey management console associated with the financial application; receiving user input, the user input comprising a user-specified authentication preference for a passkey type; associating the passkey type with a passkey permission based on the user input; receiving a request for a financial service associated with the financial application; confirming the user-specified authentication preference for the passkey type based on the passkey permission to identify a passkey to employ for the financial service; and authenticating the financial service using the passkey.

In Example 20, the subject matter of Example 19 includes, wherein the passkey type comprises one of a device-bound passkey or a cloud-synced passkey.

Example 21 is at least one machine-readable medium including instructions that, when executed by processing circuitry, cause the processing circuitry to perform operations to implement of any of Examples 1–20.

Example 22 is an apparatus comprising means to implement of any of Examples 1–20.

Example 23 is a system to implement of any of Examples 1–20.

Example 24 is a method to implement of any of Examples 1–20.

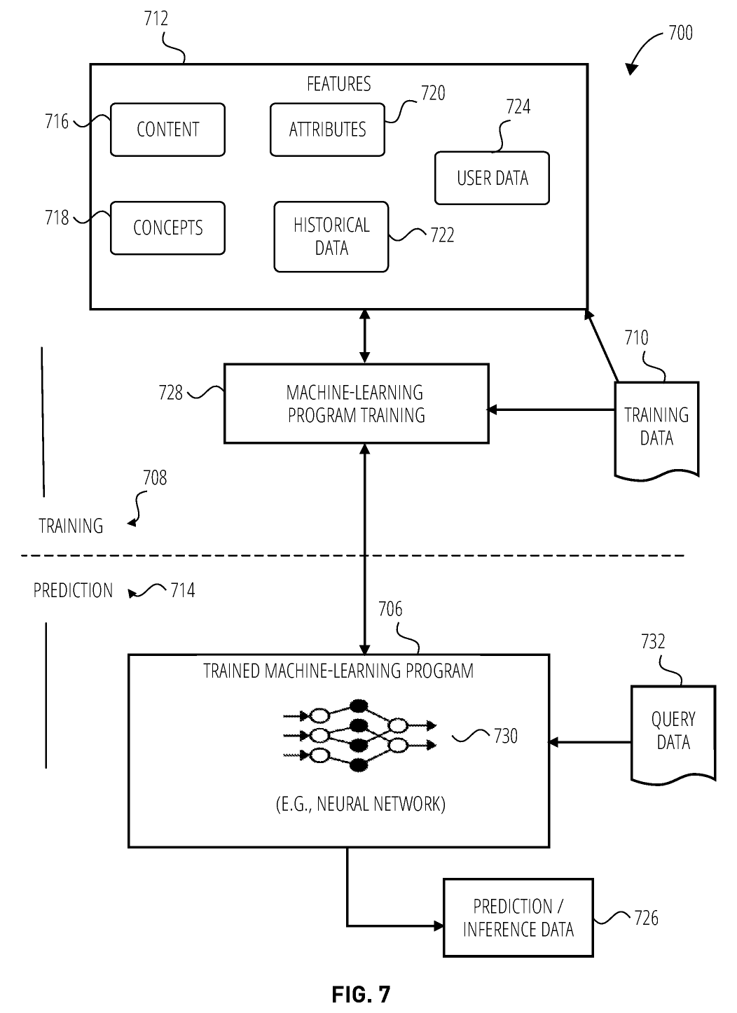

FIG. 6 depicts a machine-learning pipeline 600 and FIG. 7 illustrates training and use of a machine-learning program (e.g., model) 700. Specifically, FIG. 6 is a flowchart depicting a machine-learning pipeline 600, according to some examples. The machine-learning pipeline 600 can be used to generate a trained model, for example the trained machine-learning program 706 of FIG. 7, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include linear regression, decision trees, and neural networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes’ theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 708 as described and depicted in connection with FIG. 7, generating a trained machine-learning program 706 may include multiple phases that form part of the machine-learning pipeline 600, including, for example, the following phases illustrated in FIG. 6: data collection and preprocessing 602, feature engineering 604, model selection and training 606, model evaluation 608, prediction 610, validation, refinement, or retraining 612, and deployment 614, or a combination thereof.

For example, data collection and preprocessing 602 can include a phase for acquiring and cleaning data to ensure that it is suitable for use in the machine learning model. This phase may also include removing duplicates, handling missing values, and converting data into a suitable format. Feature engineering 604 can include a phase for selecting and transforming the training data 710 to create features that are useful for predicting the target variable. Feature engineering may include (1) receiving features 712 (e.g., as structured or labeled data in supervised learning) and/or (2) identifying features 712 (e.g., unstructured, or unlabeled data for unsupervised learning) in training data 710. Model selection and training 606 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 608 can include a phase for evaluating the performance of a trained model (e.g., the trained machine-learning program 706) on a separate testing dataset. This phase can help determine if the model is overfitting or underfitting and determine whether the model is suitable for deployment. Prediction 610 can include a phase for using a trained model (e.g., trained machine-learning program 706) to generate predictions on new, unseen data. Validation, refinement or retraining 612 can include a phase for updating a model based on feedback generated from the prediction phase, such as new data or user feedback. Deployment 614 can include a phase for integrating the trained model (e.g., the trained machine-learning program 706) into a more extensive system or application, such as a web service, mobile app, or IoT device. This phase can involve setting up APIs, building a user interface, and ensuring that the model is scalable and can handle large volumes of data.

FIG. 7 illustrates further details of two example phases, namely a training phase 708 (e.g., part of the model selection and training 606) and a prediction phase 714 (part of prediction 610). Prior to the training phase 708, feature engineering 604 is used to identify features 712. This may include identifying informative, discriminating, and independent features for effectively operating the trained machine-learning program 706 in pattern recognition, classification, and regression. In some examples, the training data 710 includes labeled data, known for pre-identified features 712 and one or more outcomes. Each of the features 712 may be a variable or attribute, such as an individual measurable property of a process, article, system, or phenomenon represented by a data set (e.g., the training data 710). Features 712 may also be of different types, such as numeric features, strings, and graphs, and may include one or more of content 716, concepts 718, attributes 720, historical data 722, and/or user data 724, merely for example and not limitation.

In training phase 708, the machine-learning pipeline 600 uses the training data 710 to find correlations among the features 712 that affect a predicted outcome or prediction/inference data 726.

With the training data 710 and the identified features 712, the trained machine-learning program 706 is trained during the training phase 708 during machine-learning program training 728. The machine-learning program training 728 appraises values of the features 712 as they correlate to the training data 710. The result of the training is the trained machine-learning program 706 (e.g., a trained or learned model).

Further, the training phase 708 may involve machine learning, in which the training data 710 is structured (e.g., labeled during preprocessing operations). The trained machine-learning program 706 implements a neural network 730 capable of performing, for example, classification and clustering operations. In other examples, the training phase 708 may involve deep learning, in which the training data 710 is unstructured, and the trained machine-learning program 706 implements a deep neural network 730 that can perform both feature extraction and classification/clustering operations.

In some examples, a neural network 730 may be generated during the training phase 708 and implemented within the trained machine-learning program 706. The neural network 730 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 730 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 730 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 708, a validation phase may be performed on a separate dataset known as the validation dataset. The validation dataset is used to tune the hyperparameters of a model, such as the learning rate and the regularization parameter. The hyperparameters are adjusted to improve the model’s performance on the validation dataset.

Once a model is fully trained and validated, in a testing phase, the model may be tested on a new dataset. The testing dataset is used to evaluate the model’s performance and ensure that the model has not overfitted the training data.

In prediction phase 714, the trained machine-learning program 706 uses the features 712 for analyzing query data 732 to generate inferences, outcomes, or predictions, as examples of a prediction/inference data 726. For example, during prediction phase 714, the trained machine-learning program 706 generates an output. Query data 732 is provided as an input to the trained machine-learning program 706, and the trained machine-learning program 706 generates the prediction/inference data 726 as output, responsive to receipt of the query data 732.

In some examples, the trained machine-learning program 706 may be a generative AI model. Generative AI is a term that may refer to any type of artificial intelligence that can create new content from training data 710. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like. For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can fool the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 726 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, eXtensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

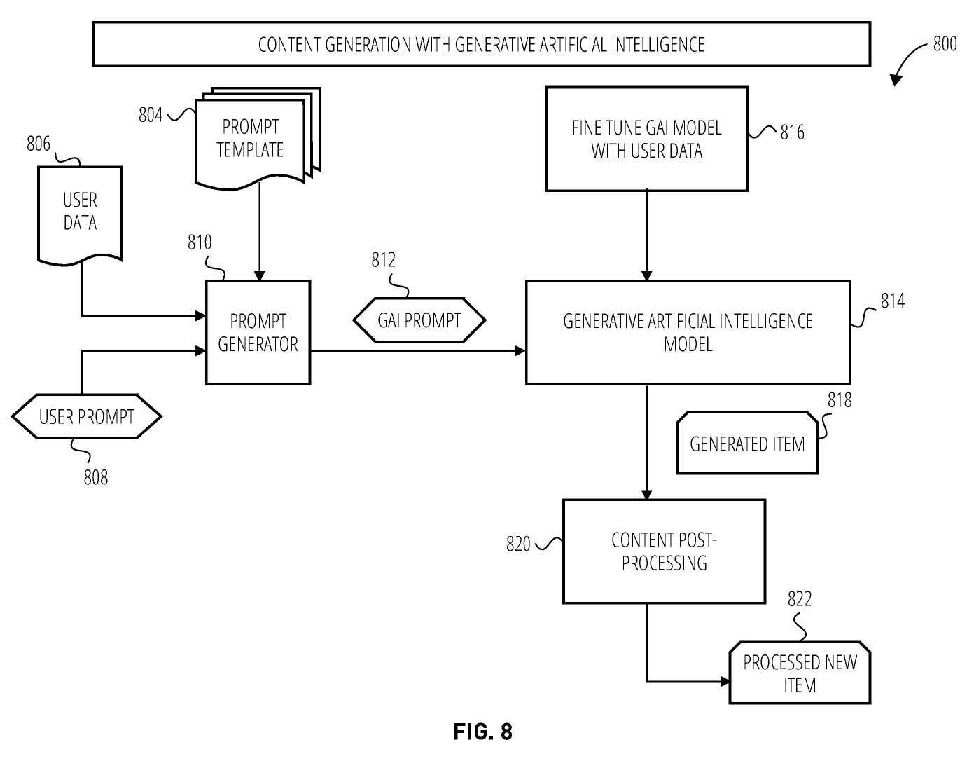

FIG. 8 illustrates a block diagram 800 employing the use of a Generative Artificial Intelligence (GAI) model 814 to generate new content, according to some examples. GAI is a type of AI that can generate new content, such as images, text, video, or audio. The GAI model 814 is trained on large datasets of data and uses this data to learn the patterns and relationships between different elements of the data. There are several types of GAI models, such as Generative Adversarial networks (GANs), Variational Autoencoders (VAEs), and Autoregressive models.

The GAI models generate items of different types, such as GAI models for creating text (e.g., GPT-4, Pathways Language Model 2 (PaLM 2), LaMDA), images (e.g., DALL-E 2, Stable Diffusion), videos (Runway Gen-2, Stable Diffusion Video), audio (e.g., Google MusicLM, Stable Audio), etc.

Often, the companies that create the GAI models make the GAI models available to users who can apply them to generate the desired content based on a GAI prompt 812 provided to the GAI model 814. Users can utilize the GAI model 814 as provided by the vendor or can optionally fine-tune 816 the GAI model 814 with their user data to adjust the parameters of the GAI model 814 in order to improve performance on a specific task or domain.

In some examples, fine-tuning the GAI model 814 includes the following operations: 1. Collect user data: Gather a collection of user data that is relevant to the target task or domain. This data could include text, images, audio, or other types of data; 2. Label the data: if the task requires supervised learning, the user data is labeled with the correct outputs; 3. Select a fine-tuning method. Some of the methods for fine-tuning GAI models include Full fine-tuning, Few-shot fine-tuning, and Prompt-based fine-tuning; 4. Train the GAI model 814: Perform incremental training of the tune 816 using the selected fine-tuning method; and 5. Optionally, evaluate the performance of the fine-tuned model on a held-out dataset.

The GAI model 814 can be used to generate new content based on the GAI prompt 812 used as input, and the GAI model 814 creates a newly generated item 818 as output.

The GAI prompt 812 is a piece of text or code that is used to instruct the GAI model 814 towards generating a desired output (e.g., generated item 818). The GAI prompt 812 provides context, instructions, and expectations for the output. The newly generated item 818 may be multi-modal, such as a piece of text, an image, a video, an audio, a piece of programming code, etc., or a combination thereof.

Prompt engineering is the process of designing and crafting prompts to effectively instruct and guide a GAI model toward generating desired outputs. It involves selecting and structuring the text that forms the GAI prompt 812 input to the GAI model 814, ensuring that the GAI prompt 812 accurately conveys the task, context, and desired style of the output.

A prompt generator 810 is a computer program that generates the GAI prompt 812. There are several ways to generate the GAI prompt 812. In one example, the prompt generator 810 may use a user prompt 808 entered by the user in plain language as the GAI prompt 812. In other examples, the prompt generator 810 creates the GAI prompt 812 without having a user prompt 808, such as by using a static pre-generated prompt based on the desired output.

In other examples, the prompt generator 810 uses a prompt template 804 to generate the GAI prompt 812. The prompt template 804 defines the structure of the GAI prompt 812 and may include fields that may be filled in based on available information to generate the GAI prompt, such as user data 806 or the user prompt 808. The prompt template may also include rules for the creating of the GAI prompt (e.g., include specific text when the recipient resides in California, but do not include the text if the recipient does not reside in California). In other examples, the prompt generator 810 uses heuristics codified into a computer program to generate the GAI prompt 812.

After the generated item 818 is generated, an optional operation 820 of content postprocessing may be performed to modify or block the newly generated item 818, resulting in a processed new item 822. The generated item 818 may be post-processed for various reasons, including improving accuracy and consistency (e.g., checking for factual errors, grammatical mistakes, or inconsistencies in style or format); enhancing quality and relevance (e.g., remove irrelevant or redundant content, improve coherence and flow, ensure that the output aligns with the intended purpose); enhancing output (e.g., polish wording, improve images, ensure that the style matches the desired effect); personalizing the new generated item 818; and ensuring ethical and responsible use.

The generated item 818 is new content, and it does not refer to content that is the result of editing or changing existing material (e.g., editing an image to include text within is not considered GAI-generated new content). One difference between the generated item 818 and material created with editing tools is that the newly generated item 818 is entirely new content, while the editing tool modifies existing content or creates the content one instruction at a time. Another difference is that the GAI model 814 can produce highly creative and imaginative content, while editing tools focus on enhancing the existing content based on user commands. Another difference is that the GAI model 814 can generate content rapidly, while the editing tools require more time and effort for thorough editing and refinement.

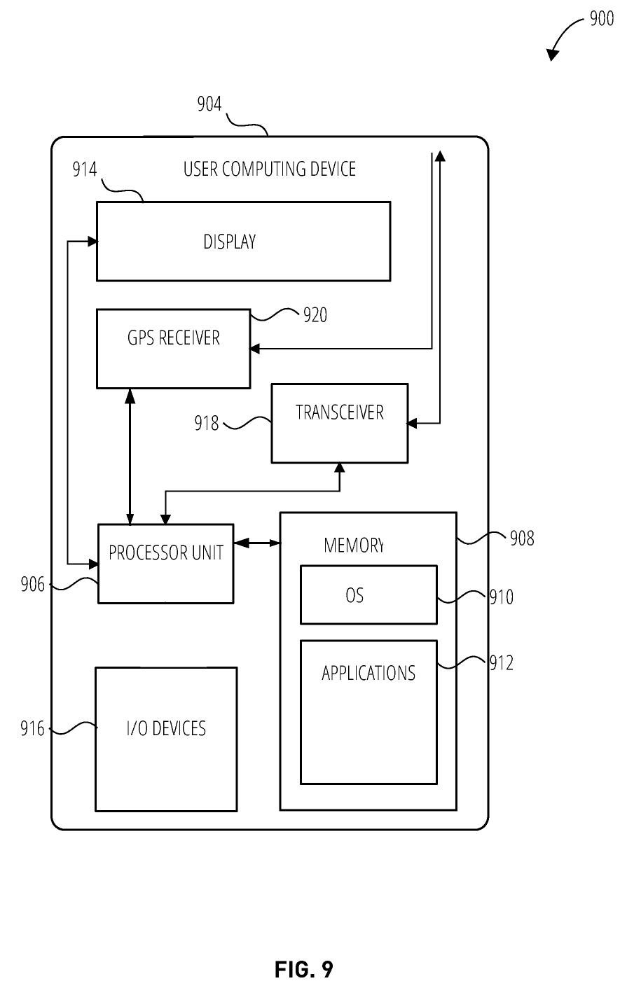

FIG. 9 is a block diagram 900 showing an example architecture of a user computing device according to some example embodiments. The block diagram 900 may, for example, describe any of the computing devices described herein, including, for example, the mobile device 110, the laptop device 112, smart watch 114, the financial institution server 108, or components thereof.

The block diagram 900 comprises a processor unit 906. The processor unit 906 may include one or more processors. Any of a variety of different types of commercially available processors suitable for computing devices may be used (e.g., an XScale architecture microprocessor, a Microprocessor without Interlocked Pipeline Stages (MIPS) architecture processor, or another type of processor). A memory 908, such as a Random Access Memory (RAM), a flash memory, or another type of memory or data storage, is typically accessible to the processor unit 906. The memory 908 may be adapted to store an operating system (OS) 910, as well as applications 912 (e.g., programs).

The processor unit 906 may be coupled, either directly or via appropriate intermediary hardware, to a display 914 and to one or more input/output (I/O) devices 916, such as a keypad, a touch panel sensor, a microphone, and the like. Such I/O devices 916 may include a touch sensor for capturing fingerprint data, a camera for capturing one or more images of the user, a retina scanner, or any other suitable devices. The I/O devices 916 may be used to implement I/O channels, as described herein. In some examples, the I/O devices 916 may also include sensors.

Similarly, in some examples, the processor unit 906 may be coupled to a transceiver 918 that interfaces with an antenna (not shown). The transceiver 918 may be configured to both transmit and receive cellular network signals, wireless data signals, or other types of signals via the antenna (not shown), depending on the nature of the computing device implemented by the architecture. Although one transceiver 918 is shown, in some examples, the architecture includes additional transceivers. For example, a wireless transceiver may be utilized to communicate according to an IEEE 1202.11 specification, such as Wi-Fi and/or a short-range communication medium. Some short-range communication mediums, such as NFC, may utilize a separate, dedicated transceiver. Further, in some configurations, a Global Positioning System (GPS) receiver 920 may also make use of the antenna to receive GPS signals. In addition to or instead of the GPS receiver 920, any suitable location-determining sensor may be included and/or used, including, for example, a Wi-Fi positioning system. In some examples, the architecture (e.g., the processor unit 906) may also support a hardware interrupt. In response to a hardware interrupt, the processor unit 906 may pause its processing and execute an interrupt service routine (ISR).

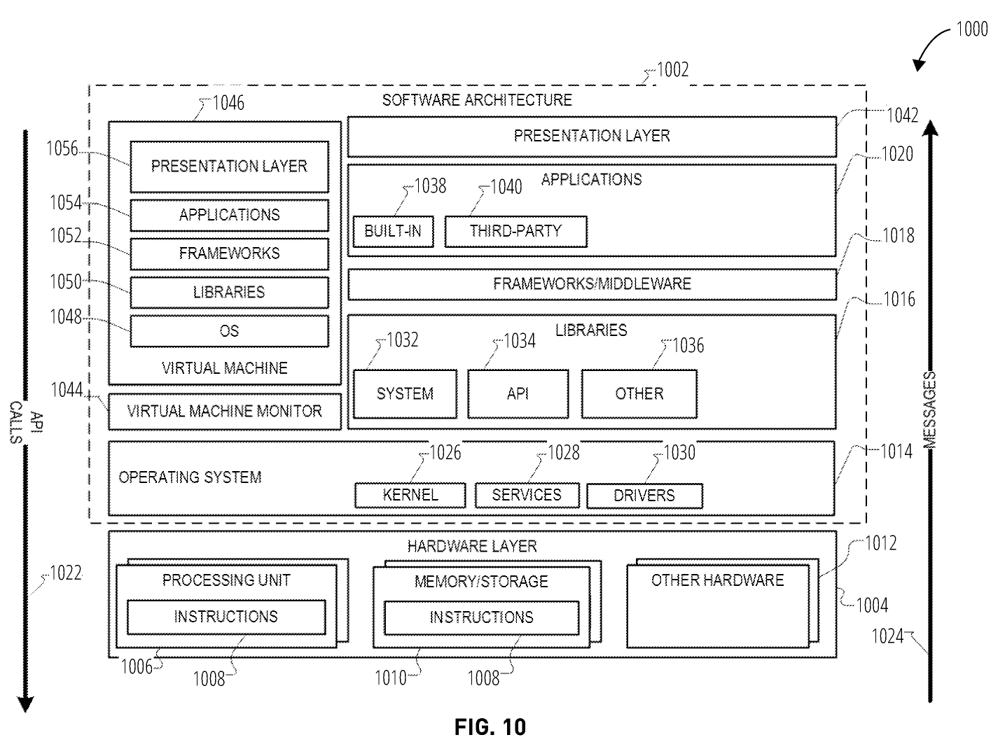

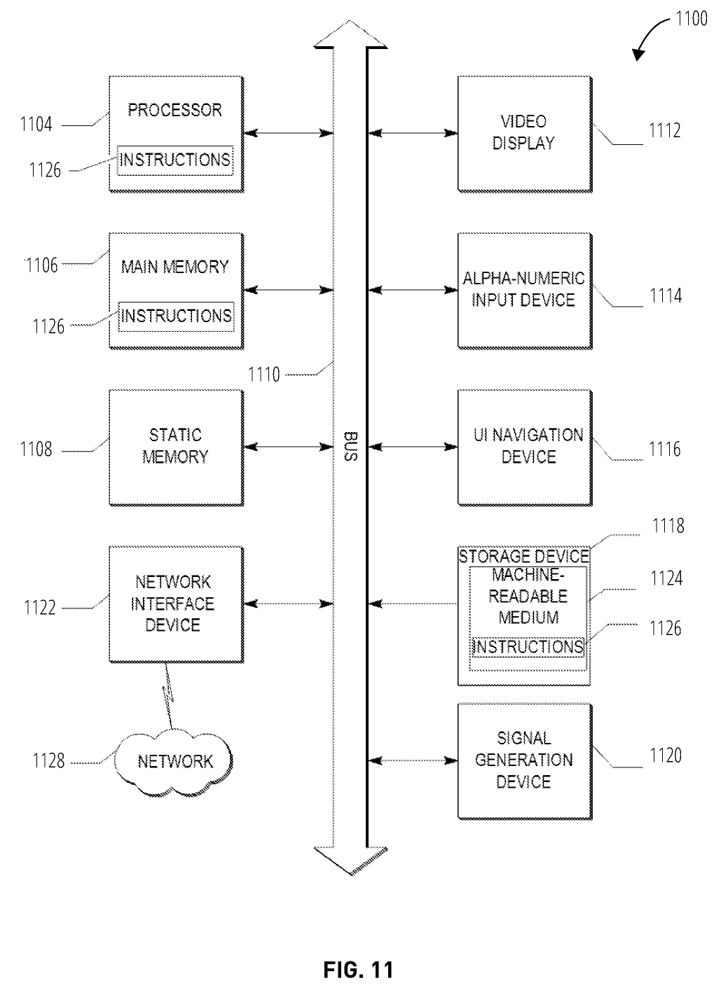

FIG. 10 is a block diagram 1000 showing one example of a processor for a computing device. The software architecture 1002 may be used in conjunction with various hardware architectures, for example, as described herein. FIG. 10 is merely a non-limiting example of a software architecture 1002, and many other architectures may be implemented to facilitate the functionality described herein. A representative hardware layer 1004 is illustrated and can represent, for example, any of the above-referenced computing devices. In some examples, the hardware layer 1004 may be implemented according to an architecture 1100 of FIG. 11 and/or the architecture 900 of FIG. 9.

The representative hardware layer 1004 comprises one or more processing units 1006 having associated executable instructions 1008. The executable instructions 1008 represent the executable instructions of the software architecture 1002, including implementation of the methods, modules, engines, components, and so forth of FIGS. 1–8. The hardware layer 1004 also includes memory and/or storage modules 1010, which also have the executable instructions 1008. The hardware layer 1004 may also comprise other hardware 1012, which represents any other hardware of the hardware layer 1004, such as the other hardware illustrated as part of the architecture 1000.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and a presentation layer 1044. Operationally, the applications 1020 and/or other components within the layers may invoke application programming interface (API) 1034 through the software stack and receive a response, returned values, and so forth illustrated as messages 1024 in response to the API calls 1022. The layers illustrated are representative in nature and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1026, services 1028, and drivers 1030. The kernel 1026 may act as an abstraction layer between the hardware and the other software layers. For example, the kernel 1026 may be responsible for memory management, processor management (e.g., scheduling), component management, networking, security settings, and so on. The services 1028 may provide other common services for the other software layers. In some examples, the services 1028 include an interrupt service. The interrupt service may detect the receipt of a hardware or software interrupt and, in response, cause the software architecture 1002 to pause its current processing and execute an ISR when an interrupt is received. The ISR may generate an alert.

The drivers 1030 may be responsible for controlling or interfacing with the underlying hardware. For instance, the drivers 1030 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1026, services 1028, and/or drivers 1030). The libraries 1016 may include system libraries 1032 (e.g., C standard library) that may provide functions such as memory allocation functions, string manipulation functions, mathematic functions, and the like. In addition, the libraries 1016 may include API libraries 1034 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1036 to provide many other APIs to the applications 1020 and other software components/modules.

The frameworks 1018 (also sometimes referred to as middleware) may provide a higher-level common infrastructure that may be utilized by the applications 1020 and/or other software components/modules. For example, the frameworks 1018 may provide various graphical user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1038 and/or third-party applications 1040. Examples of representative built-in applications 1038 may include, but are not limited to, a contacts application, a browser application, a book reader application, a location application, a media application, a messaging application, and/or a game application. The third-party applications 1040 may include any of the built-in applications 1038 as well as a broad assortment of other applications. In a specific example, the third-party application 1040 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 1038 may invoke the API calls 1034 provided by the mobile operating system such as the operating system 1014 to facilitate functionality described herein.

The applications 1020 may utilize built-in operating system functions (e.g., kernel 1026, services 1028, and/or drivers 1030), libraries (e.g., system libraries 1032, API libraries 1034, and other libraries 1036), or frameworks/middleware 1018 to create user interfaces to interact with users of the system. Alternatively, or additionally, in some systems, interactions with a user may occur through a presentation layer, such as the presentation layer 1042. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 10, this is illustrated by a virtual machine 1044. A virtual machine creates a software environment where applications/modules can execute as if they were executing on a hardware computing device. The virtual machine 1044 is hosted by a host operating system (e.g., the operating system 1014) and typically, although not always, has a virtual machine monitor 1044, which manages the operation of the virtual machine 1044 as well as the interface with the host operating system (e.g., the operating system 1014). A software architecture executes within the virtual machine 1044, such as an operating system 1048, libraries 1050, frameworks/middleware 1052, applications 1054, and/or a presentation layer 1056 within the VM 1046. These layers of software architecture executing within the virtual machine 1046 can be the same as corresponding layers previously described or may be different.

FIG. 11 is a block diagram illustrating a computing device hardware architecture 1100, within which a set or sequence of instructions can be executed to cause a machine to perform examples of any one of the methodologies discussed herein. The architecture 1100 may describe, for example, any of the computing devices and/or control circuits described herein.

The architecture 1100 may execute the software architecture 1002 described with respect to FIG. 10. The architecture 1100 may operate as a standalone device or may be connected (e.g., networked) to other machines. In a networked deployment, the architecture 1100 may operate in the capacity of either a server or a client machine in server-client network environments, or it may act as a peer machine in peer-to-peer (or distributed) network environments. The architecture 1100 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1100 includes a processor 1104 comprising at least one processor (e.g., a central processing unit (CPU), a graphics processing unit (GPU), or both, processor cores, compute nodes, etc.). The architecture 1100 may further comprise a main memory 1106 and a static memory 1108, which communicate with each other via a link 1110 (e.g., a bus). The architecture 1100 can further include a video display unit 1112, an alphanumeric input device 1114 (e.g., a keyboard), and a UI navigation device 1116 (e.g., a mouse). In some examples, the video display unit 1112, alphanumeric alpha-numeric input device 1114, and UI navigation device 1116 are incorporated into a touchscreen display. The architecture 1100 may additionally include a storage device 1118 (e.g., a drive unit), a signal generation device 1120 (e.g., a speaker), a network interface device 1122, and one or more sensors (not shown), such as a GPS sensor, compass, accelerometer, or other sensor.

In some examples, the processor unit 1104 or another suitable hardware component may support a hardware interrupt. In response to a hardware interrupt, the processor unit 1104 may pause its processing and execute an ISR, for example, as described herein.

The storage device 1118 includes a machine-readable medium 1124 on which is stored one or more sets of data structures and instructions 1126 (e.g., software) embodying or utilized by any one or more of the methodologies or functions described herein. The instructions 1126 can also reside, completely or at least partially, within the main memory 1106, within the static memory 1108, and/or within the processor unit 1104 during execution thereof by the architecture 1100, with the main memory 1106, the static memory 1108, and the processor unit 1104 also constituting machine-readable media. The instructions 1126 stored at the machine-readable medium 1124 may include, for example, instructions for implementing the software architecture 1002, instructions for executing any of the features described herein, etc.

While the machine-readable medium 1124 is illustrated in an example to be a single medium, the term “machine-readable medium” can include a single medium or multiple media (e.g., a centralized or distributed database, and/or associated caches and servers) that store the one or more instructions 1124. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

The instructions 1126 can further be transmitted or received over a communications network 1128 using a transmission medium via the network interface device 1122 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 3G, 4G, and 5G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

The machine in architecture 1100 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Another embodiment takes the form of a system that includes at least one processor, and that also includes one or more non-transitory computer readable storage media (CRM) containing instructions executable by the at least one processor for causing the at least one processor to perform at least the operations that are listed in the preceding paragraph. Still another embodiment takes the form of one or more non-transitory CRMs containing instructions executable by at least one processor for causing the at least one processor to perform at least those operations.

Furthermore, a number of variations and permutations of the above-listed embodiments are described herein, and it is expressly noted that any variation or permutation that is described in this disclosure can be implemented with respect to any type of embodiment. For example, a variation or permutation that is primarily described in this disclosure in connection with a method embodiment could just as well be implemented in connection with a system embodiment and/or a CRM embodiment. Furthermore, this flexibility and cross-applicability of embodiments is present in spite of any slightly different language (e.g., processes, methods, methodologies, steps, operations, functions, and/or the like) that is used to describe and/or characterize such embodiments and/or any element or elements thereof.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A system for managing digital authentication in a financial application, the system comprising:
one or more hardware processors of a machine; and
at least one memory storing instructions that, when executed by the one or more hardware processors, cause the system to perform operations comprising:
causing a user interface to be displayed to a user of the financial application, the user interface comprising a passkey control center for providing a centralized passkey management console associated with the financial application;
receiving, via the user interface, user input, the user input comprising a user-specified authentication preference for a passkey type;
associating the passkey type with a passkey permission based on the user input;
receiving, via the user interface, a request for a financial service associated with the financial application;
confirming the user-specified authentication preference for the passkey type based on the passkey permission to identify a passkey to employ for the financial service; and
authenticating the financial service using the passkey.

2. The system of claim 1, the operations further comprising:
monitoring a financial transaction to confirm conformance to the user-specified authentication preference for the passkey.

3. The system of claim 2, the operations further comprising:
determining a risk level of the financial transaction based on the user-specified authentication preference; and
selecting a corresponding passkey based on the user-specified authentication preference and the risk level of the financial transaction.

4. The system of claim 1, wherein the passkey type comprises one of a device-bound passkey or a cloud-synced passkey.

5. The system of claim 4, wherein the user-specified authentication preference includes:
identifying an allowed authentication method for the device-bound passkey.

6. The system of claim 4, the operations further comprising:
defining a usage context for the cloud-synced passkey to be used within the financial application based on a contextual factor.

7. The system of claim 4, the operations further comprising:
identifying a high-risk financial service; and
restricting the high-risk financial service to the device-bound passkey.

8. The system of claim 1, the operations further comprising:
monitoring the passkey control center for types of transactions comprising low-risk activities; and
suggesting a change to the passkey type based on the monitoring.

9. The system of claim 1, wherein the passkey control center is implemented as a container within a security center of the financial application.

10. A method for managing digital authentication in a financial application, the method comprising:
causing a user interface to be displayed to a user of the financial application, the user interface comprising a passkey control center for providing a centralized passkey management console associated with the financial application;
receiving user input, the user input comprising a user-specified authentication preference for a passkey type;
associating the passkey type with a passkey permission based on the user input;
receiving a request for a financial service associated with the financial application;
confirming the user-specified authentication preference for the passkey type based on the passkey permission to identify a passkey to employ for the financial service; and
authenticating the financial service using the passkey.

11. The method of claim 10, further comprising:
monitoring a financial transaction to confirm conformance to the user-specified authentication preference for the passkey.

12. The method of claim 11, further comprising:
determining a risk level of the financial transaction based on the user-specified authentication preference; and
selecting a corresponding passkey based on the user-specified authentication preference and the risk level of the financial transaction.

13. The method of claim 10, wherein the passkey type comprises one of a device-bound passkey or a cloud-synced passkey.

14. The method of claim 13, wherein the user-specified authentication preference includes:
identifying an allowed authentication method for the device-bound passkey.

15. The method of claim 13, further comprising:
defining a usage context for the cloud-synced passkey to be used within the financial application based on a contextual factor.

16. The method of claim 13, further comprising:
identifying a high-risk financial service; and
restricting the high-risk financial service to the device-bound passkey.

17. The method of claim 10, further comprising:
monitoring the passkey control center for types of transactions comprising low-risk activities; and
suggesting a change to the passkey type based on the monitoring.

18. The method of claim 10, wherein the passkey control center is implemented as a module within a security center of the financial application.

19. A non-transitory machine-storage medium embodying instructions for managing digital authentication in a financial application that, when executed by a machine, cause the machine to perform operations comprising:
causing a user interface to be displayed to a user of the financial application, the user interface comprising a passkey control center for providing a centralized passkey management console associated with the financial application;
receiving user input, the user input comprising a user-specified authentication preference for a passkey type;
associating the passkey type with a passkey permission based on the user input;
receiving a request for a financial service associated with the financial application;
confirming the user-specified authentication preference for the passkey type based on the passkey permission to identify a passkey to employ for the financial service; and
authenticating the financial service using the passkey.

20. The non-transitory machine-storage medium of claim 19, wherein the passkey type comprises one of a device-bound passkey or a cloud-synced passkey.
